(19) United States
(12) Patent Application Publication
(10) Pub. No.: US 2009/0009331 A1
(43) Pub. Date: Jan. 8, 2009

(54) WIRELESS TAG READER/WRITER AND COMMUNICATION METHOD FOR USE IN WIRELESS TAG READER/WRITERS

(75) Inventor: Shuji Oozawa, Mishima-shi (JP)

Correspondence Address: AMIN, TUROCY & CALVIN, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/043,351

(22) Filed: Mar. 6, 2008

(30) Foreign Application Priority Data
Jul. 5, 2007 (JP) 2007-177443

(51) Int. Cl. G08B 13/14

(52) U.S. Cl. 340/572.1

(57) ABSTRACT

A wireless tag reader/writer comprises a plurality of communication antennas and a wireless tag reader/writer main unit. The communication antennas are arranged in a direction in which wireless tags pass and configured to transmit and receive signals to and from the wireless tags. The wireless tag reader/writer main unit processes signals to transmit to the wireless tags and signals received from the wireless tags. The wireless tag reader/writer unit changes the intensity of the electric waves to be radiated from the communication antennas, thereby selecting a wireless tag with which the wireless tag reader/writer is to communicate.

### CROSS-REFERENCE TO RELATED APPLICATIONS

This application is based upon and claims the benefit of priority from the prior Japanese Patent Application No. 2007-177443, filed on Jul. 5, 2007; the entire contents of which are incorporated herein by reference.

### BACKGROUND OF THE INVENTION

1. Field of the Invention

The present invention relates to a wireless tag reader/writer that transmits and receives signals to and from wireless tags. More particularly, the invention relates to a wireless tag reader/writer that can designate a specific one of wireless tags located around the reader/writer, from which the reader/writer should read data. The invention also relates to a communication method designed for use in wireless tag reader/writers.

2. Description of the Related Art

Consider a wireless tag reader/writer installed at the entrance/exit of a library, for preventing theft. A plurality of wireless tags may exist around this wireless tag reader/writer. In this case, the electric waves radiated from the reader/writer reach these wireless tags, inevitably resulting in data-reading errors. In connection with such data-reading errors, a technique has been proposed (see Jpn. Pat. Appln. Laid-Open Publication No. 2005-69861). The technique is to provide a plurality of antennas on a wireless tag reader/writer and make the reader/writer perform communication with only the wireless tag or tags from which all antennas have received data.

Another technique has been proposed (see Jpn. Pat. Appln. Laid-Open Publication No. 2003-150916). This technique is to use a plurality of wireless tag reader/writers and incorporate in each reader/writer a device that functions as a wireless tag, thereby preventing interference of electric waves.

The techniques described above, however, cannot prevent data-reading errors, if a plurality of wireless tags exist near one antenna.

Further, data-reading errors develop if a plurality of wireless tags exist near one reader/writer.

### BRIEF SUMMARY OF THE INVENTION

According to embodiments of the present invention, an object of the invention is to provide a wireless tag reader/writer that can perform communication with selected ones of many wireless tags existing around it, and a communication method designed for use in wireless tag reader/writers.

The present invention may provide a wireless tag reader/writer comprising: a plurality of communication antennas arranged in a direction in which wireless tags pass and configured to transmit and receive signals to and from the wireless tags; and a wireless tag reader/writer main unit configured to process signals to transmit to the wireless tags and signals received from the wireless tags. The wireless tag reader/writer main unit changes the intensity of the electric waves radiated from the communication antennas that are provided at the entrance or exit of a passage of wireless tags, thereby selecting a wireless tag with which the wireless tag reader/writer is to communicate.

### BRIEF DESCRIPTION OF THE DRAWINGS

FIG. 1 is a schematic diagram showing the configuration of a wireless tag reader/writer according to an embodiment of this invention;

FIGS. 2A and 2B are diagrams explaining how the wireless tag reader/writer according to the embodiment radiates electric waves;

FIG. 3 is a flowchart explaining the tag-identifying process the wireless tag reader/writer performs; and

FIG. 4 is a diagram outlining the configuration of a wireless tag and the configuration of the wireless tag reader/writer according to the embodiment.

### DETAILED DESCRIPTION OF THE INVENTION

A wireless tag reader/writer and a communication method, both according to an embodiment of this invention, will be described in detail with reference to the accompanying drawings. Note that the wireless tag reader/writer according to the present invention includes a device for reading information from wireless tags or a device for writing information in the wireless tags, or both devices. The term “wireless tag” means a recording medium with which radio communication can be achieved. Most wireless tags have an antenna and an IC chip. The wireless tag may further have a calculating function. Preferably, the wireless tag should have a portable size. Nonetheless, it may be much smaller. The wireless tag is known also as radio frequency identification (RFID).

### Configuration of the Wireless Tag and the Configuration of the Wireless tag Reader/Writer According to the Embodiment

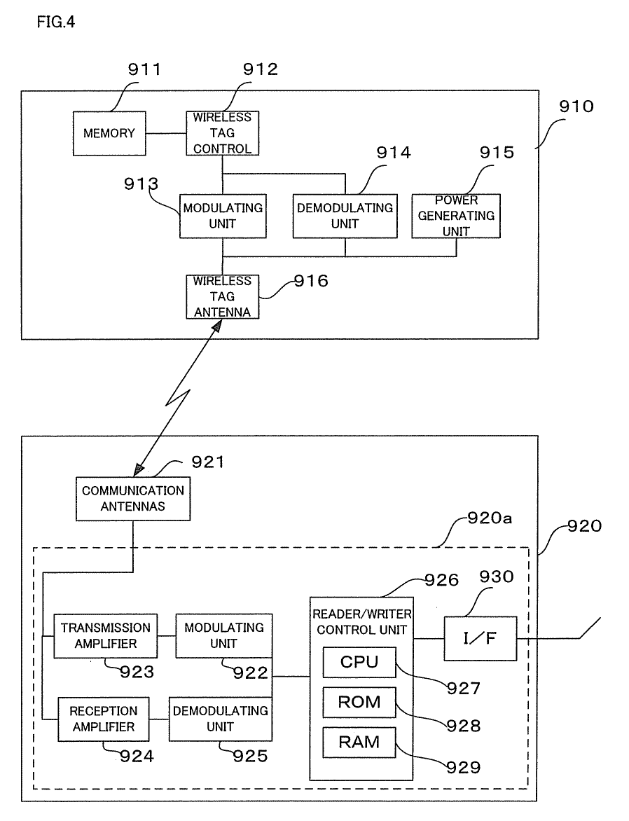

First, the wireless tag and the wireless tag reader/writer according to the embodiment will be described. FIG. 4 is a diagram outlining the configuration of the wireless tag 910 and that of the wireless tag reader/writer 920.

The wireless tag 910 comprises a memory 911, a wireless tag control unit 912, a power-supply generating unit 915, a modulating unit 913, and a demodulating unit 914. The memory 911 is a storage device. The wireless tag control unit 912 can write and read data into and from the memory 911. The power-supply generating unit 915 rectifies and stabilizes any modulated electromagnetic wave received, thus generating power. The modulating unit 913 modulates the data supplied from the wireless tag control unit 912 and supplies the data to a wireless tag antenna 916. The demodulating unit 914 receives the modulated electromagnetic wave and demodulates the same. The wave demodulated is supplied to the wireless tag control unit 912 by the demodulating unit 914.

The wireless tag reader/writer 920 includes a reader/writer main unit 920a and communication antennas 921. The communication antennas 921 transmit and receive signals to and from the wireless tag in the form of electromagnetic waves.

The reader/writer main unit 920a comprises a reader/writer control unit 926, a modulating unit 922, a transmission amplifier 923, a reception amplifier 924, a demodulating unit 925, and an interface 930. The reader/writer control unit 926 controls the communication with the wireless tag 910 and hardware to be connected. The modulating unit 922 modulates the data supplied from the reader/writer control unit 926. The transmission amplifier 923 amplifies a modulated signal and transmits the same to the communication antennas 921. The reception amplifier 924 amplifies any modulated electromagnetic wave received. The demodulating unit 925 demodulates any modulated signal received. The interface 930 is connected to a high-order apparatus, such as a personal computer, and receives and transmits data from and to the higher-order apparatus. The reader/writer control unit 926 has a CPU 927, a ROM 928, and a RAM 929. The ROM 928 and RAM 929 store various data items.

The wireless tag reader/writer according to the embodiment will be described in detail. FIG. 1 is a schematic diagram showing the configuration of the wireless tag reader/writer according to the embodiment. As shown in FIG. 1, the wireless tag reader/writer according to the embodiment comprises a plurality of communication antennas and a wireless tag reader/writer main unit 101. The communication antennas are arranged in the direction in which wireless tags pass and can transmit and receive signals to and from the wireless tags. The wireless tag reader/writer main unit 101 processes the signals received from the wireless tags and the signals to transmit to the wireless tags.

Some of the communication antennas may be provided on one of a pair of gate-shaped structures 102, and the remaining communication antennas may be provided on the other of the structures 102. For example, two entrance-side communication antennas 102a1 and 102a2 are provided at the entrances through which the wireless tag enters the structures 102; two middle communication antennas 102b1 and 102b2 are provided within the structures 102; and two exit-side communication antennas 102c1 and 102c2 are provided at the exits through which the wireless tag comes out of the structures 102. Three or more middle antennas 102b may be provided in each of the structures 102. No middle communication antennas 102b may be used at all.

### Operation of the Wireless Tag Reader/Writer According to Embodiment

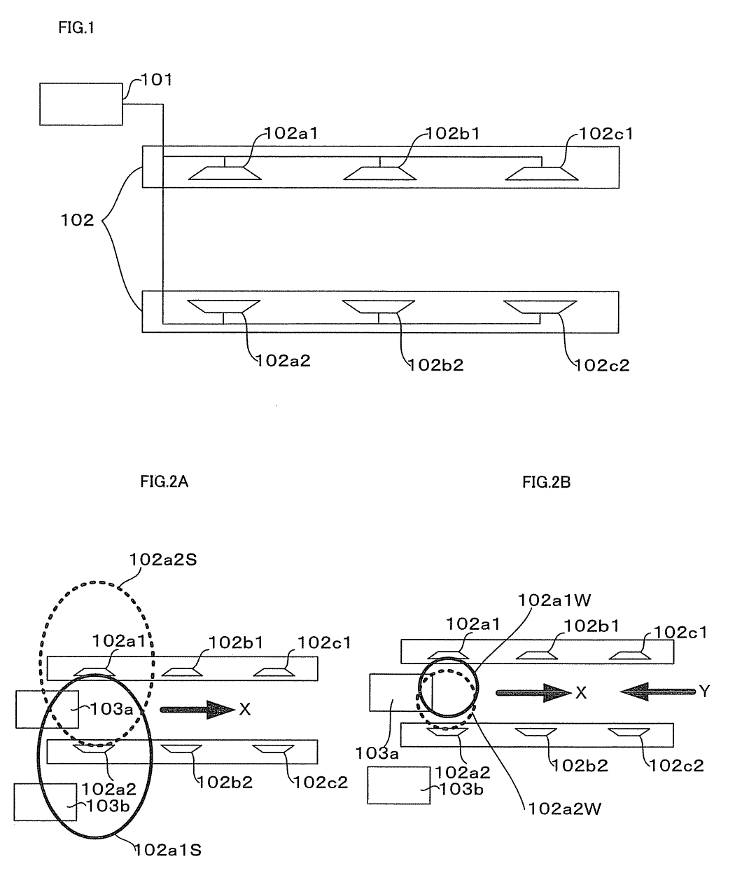

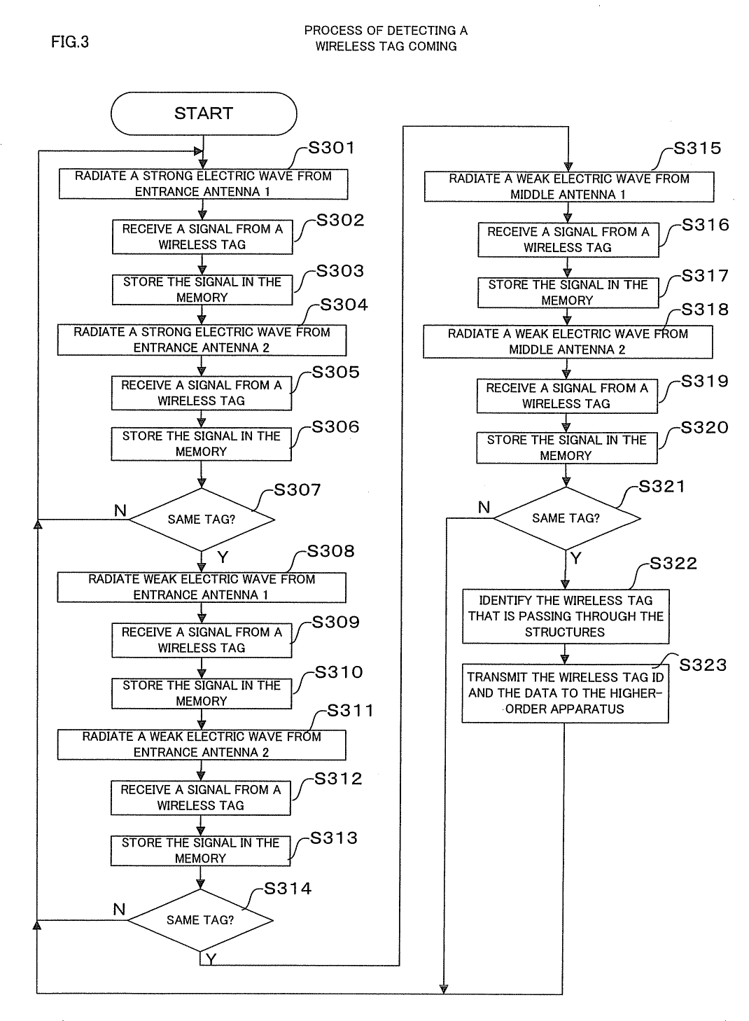

FIGS. 2A and 2B are diagrams explaining how the wireless tag reader/writer according to the embodiment radiates electric waves. In FIGS. 2A and 2B, the waves radiated from the middle communication antennas 102b1 and 102b2 and exit-side communication antennas 102c1 and 102c2 are not illustrated.

In the wireless tag reader/writer according to the embodiment, the wireless tag reader/writer main unit 101 causes either the entrance-side communication antennas provided or the exit-side communication antennas to radiate strong electric waves. If wireless tags are detected, the entrance-side communication antennas or the exit-side communication antennas radiate weak electric waves, thereby selecting a wireless tag with which the reader/writer should communicate.

In the method that the wireless tag reader/writer according to the embodiment performs to communicate with any wireless tag, the wireless tag reader/writer main unit 101 changes the intensity of the electric waves radiated from the entrance-side communication antennas or the exit-side communication antennas. The wireless tag with which the reader/writer should communicate is thereby selected.

Further, in the communication method the wireless tag reader/writer according to the embodiment performs, the wireless tag reader/writer main unit 101 causes the entrance-side communication antennas or the exit-side communication antennas to radiate strong electric waves. If wireless tags are thereby detected, the wireless tag reader/writer main unit 101 causes the entrance-side communication antennas or the exit-side communication antennas to radiate weak electric waves, thereby selecting a wireless tag with which the reader/writer should communicate.

As shown in FIG. 2A, the entranced-side communication antenna 102a1 radiates a strong electric wave 102a1S of, for example, 500 mW in the wireless tag reader/writer according to the embodiment. Then, the other entranced-side communication antenna 102a2 radiates strong electric wave 102a2S of, for example, 500 mW.

Assume that a plurality of wireless tags 103a and wireless tags 103b exist near the wireless tag reader/writer according to the embodiment. The electric wave 102a1S radiated from the entrance-side communication antenna 102a1 reaches the wireless tag 103a and the wireless tag 103b. Thus, the reader/writer therefore performs communication with these wireless tags.

On the other hand, the electric wave 102a2S radiated from the entrance-side communication antenna 102a2 reaches the wireless tag 103a only. Hence, the reader/writer therefore performs communication with the wireless tag 103a.

The identifier of the radio tag 103a with which the reader/writer communicates via both entrance-side communication antennas 102a1 and 102a2 is stored, in a memory, as a candidate tag that may enter the gate-shaped structures 102.

If such a candidate tag exists, the wireless tag reader/writer according to the embodiment weakens the electric waves being transmitted from the entrance-side communication antennas 102a1 and 102a2. FIG. 2B illustrates the case where the antennas 102a1 and 102a2 radiate weak electric waves 102a1W and 102a2W of, for example, 250 mW, respectively. As seen from FIG. 2B, the wireless tag reader/writer may perform communication with the wire tag 103a by using both entrance-side communication antennas 102a1 and 102a2, though the electric waves 102a1W and 102a2W that are weak. In this case, the wireless tag reader/writer according to the embodiment determines that the wireless tag 103a is one passing through the gate-shaped structures 102. This decision is transmitted to the higher-order apparatus.

The electric waves 102a1W and 102a2W are too weak to leak outside the gate-shaped structures 102. This can enhance the accuracy of selecting a wireless tag with which to communicate.

If only weak electric waves are radiated from the beginning, data may not be read from any wireless tag that moves at high speed. In view of this, the electric waves must be weakened after strong electric waves have been radiated and a candidate tag has been detected, which may enter the gate-shaped structures 102.

The exit-side communication antennas 102c1 and 102c2 are operated in similar way as the entrance-side communication antennas 102a1 and 102a2. Thus, the wireless tag reader/writer according to the embodiment can select any wireless tag with which to communicate, even if the wireless tags move in the direction of arrow Y in FIG. 2B.

The wireless tag reader/writer according to the embodiment can be configured to determine the direction in which the wireless tag communicating with it is moving, from the time difference between the signal one of the communication antennas receives from this wireless tag and the signals the other communication antennas receive from other wireless tags.

Assume that the entrance-side communication antennas 102a1 and 102a2 first communicate with a certain wireless tag and the middle communication antennas 102b1 and 102b2 then communicate with this wireless tag. In this case, the wireless tag reader/writer according to the embodiment determines that this wireless tag is moving in the direction of arrow X shown in FIG. 2B.

Also, assume that the exit-side communication antennas 102c1 and 102c2 first communicate with a certain wireless tag and the middle communication antennas 102b1 and 102b2 then communicate with this wireless tag. In this case, the wireless tag reader/writer according to the embodiment determines that this wireless tag is moving in the direction of arrow Y shown in FIG. 2B.

A process of identifying any wireless tag that enters the gate-shaped structure 102 will be explained with reference to FIG. 3. FIG. 3 is a flowchart explaining the tag-identifying process performed by the wireless tag reader/writer according to the embodiment. Hereinafter, the entrance-side communication antennas 102a1 and 102a2 will be called “entrance antenna 1” and “entrance antenna 2,” respectively, and the middle communication antennas 102b1 and 102b2 will be called “middle antenna 1” and “middle antenna 2,” respectively”.

In Step S301, the wireless tag reader/writer according to the embodiment causes the entrance antenna 1 to radiate a strong electric wave. In Step S302, the wireless tag reader/writer according to the embodiment receives signals from the near-by wireless tags. In Step S303, the wireless tag reader/writer according to the embodiment stores, in the memory, the IDs of the wireless tags with which it has just communicated.

Next, in Step S304, the wireless tag reader/writer according to the embodiment causes the entrance antenna 2 to radiate a strong electric wave. In Step S305, the wireless tag reader/writer according to the embodiment receives signals from the near-by wireless tags. In Step S306, the wireless tag reader/writer according to the embodiment stores, in the memory, the IDs of the wireless tangs with which it has just communicated.

Then, in Step S307, the wireless tag reader/writer according to the embodiment refers to the memory, determining whether the memory contains the ID of any wireless tag that has communicated with both entrance antennas 1 and 2. If the ID of such a wireless tag is held in the memory, the wireless tag reader/writer according to the embodiment goes to Step S308. If the ID of such a wireless tag is not held in the memory, it returns to Step S301.

In Step S308, the wireless tag reader/writer according to the embodiment causes the entrance antenna 1 to radiate a weak electric wave. In Step S309, the wireless tag reader/writer according to the embodiment receives signals from the near-by wireless tags. In Step S310, the wireless tag reader/writer according to the embodiment stores, in the memory, the IDs of the wireless tags with which it has just communicated.

Next, in Step S311, the wireless tag reader/writer according to the embodiment causes the entrance antenna 2 to radiate a weak electric wave. In Step S312, the wireless tag reader/writer according to the embodiment receives signals from the near-by wireless tags. In Step S313, the wireless tag reader/writer according to the embodiment stores, in the memory, the IDs of the wireless tags with which it has just communicated.

In Step S314, the wireless tag reader/writer according to the embodiment refers to the memory, determining whether the memory contains the ID of any wireless tag that has communicated with both entrance antennas 1 and 2. If the ID of such a wireless tag is held in the memory, the wireless tag reader/writer according to the embodiment goes to Step S315. If the ID of such a wireless tag is not held in the memory, it returns to Step S301.

In Step S315, the wireless tag reader/writer according to the embodiment causes the middle antenna 1 to radiate a weak electric wave. In Step S316, the wireless tag reader/writer according to the embodiment receives signals from the near-by wireless tags. In Step S317, the wireless tag reader/writer according to the embodiment stores, in the memory, the IDs of the wireless tags with which it has just communicated.

Next, in Step S318, the wireless tag reader/writer according to the embodiment causes the middle antenna 2 to radiate a weak electric wave. In Step S319, the wireless tag reader/writer according to the embodiment receives signals from the near-by wireless tags. In Step S320, the wireless tag reader/writer according to the embodiment stores, in the memory, the IDs of the wireless tags with which it has just communicated.

In Step S321, the wireless tag reader/writer according to the embodiment refers to the memory, determining whether the memory contains the ID of any wireless tag that has communicated with both middle antennas 1 and 2. If the ID of such a wireless tag is held in the memory, the wireless tag reader/writer according to the embodiment goes to Step S322. If the ID of such a wireless tag is not held in the memory, it returns to Step S301.

In Step S322, the wireless tag reader/writer according to the embodiment identifies the wireless tag with both middle antennas 1 and 2 have communicated, as a wireless tag that is passing through the structures 102 and also determines that this wireless tag is moving in the direction of arrow X.

In Step S323, the wireless tag reader/writer according to the embodiment transmits the ID of the wireless tag and the data representing the direction in which this wireless tag is moving, to the higher-order apparatus which is, for example, a personal computer.

As has been described, the wireless tag reader/writer according to the embodiment comprises a plurality of communication antennas, which are arranged in the direction in which wireless tags pass and can transmit and receive signals to and from the wireless tags. The reader/writer changes the intensity of the electric waves radiated from the side communication antennas, selecting a wireless tag to be communicated. Hence, the wireless tag reader/writer can select a wireless tag and communicate with the wireless tag selected, even if other wireless tags exist around it.

It should be noted that the present invention is not limited to the various embodiments described above. The components of any embodiment can be modified in various manners in reducing the invention to practice, without departing from the sprit or scope of the invention. Further, the components of the embodiments described above may be combined, if necessary, in appropriate ways, thereby to make different inventions. Still further, some of the components of any embodiment may not be used. Moreover, the components of the different embodiments may be combined in any desired fashion.

What is claimed is:

1. A wireless tag reader/writer comprising:
a plurality of communication antennas arranged in a direction in which wireless tags pass and configured to transmit and receive signals to and from the wireless tags; and
a wireless tag reader/writer main unit configured to process signals to transmit to the wireless tags and signals received from the wireless tags,
wherein the wireless tag reader/writer main unit changes the intensity of the electric waves radiated from the communication antennas which are provided at the entrance or exit of a passage of wireless tags, thereby selecting a wireless tag with which the wireless tag reader/writer is to communicate.

2. The wireless tag reader/writer according to claim 1, wherein the wireless tag reader/writer main unit causes the communication antennas provided at the entrance or exit to radiate strong electric waves, thereby to detect the wireless tags, and when the wireless tags are thereby detected, the wireless tag reader/writer main unit causes the communication antennas provided at the entrance or exit to radiate weak electric waves, thereby to select a wireless tag with which the wireless tag reader/writer is to communicate.

3. The wireless tag reader/writer according to claim 1, wherein the direction in which one wireless tag is moving is determined from the time difference of the signal coming from the one wireless tag received by the communication antennas.

4. The wireless tag reader/writer according to claim 2, wherein the direction in which one wireless tag is moving is determined from the time difference of the signal coming from the one wireless tag received by the communication antennas.

5. The wireless tag reader/writer according to claim 1, wherein the communication antennas are provided in a pair of gate-shaped structures, the communication antennas includes the antennas provided at the entrance, the antennas provided at the exit, and middle communication antennas provided almost half way between the antennas provided at the entrance and the antennas provided at the exit.

6. The wireless tag reader/writer according to claim 2, wherein the communication antennas are provided in a pair of gate-shaped structures, the communication antennas includes the antennas provided at the entrance, the antennas provided at the exit, and middle communication antennas provided almost half way between the antennas provided at the entrance and the antennas provided at the exit.

7. The wireless tag reader/writer according to claim 3, wherein the communication antennas are provided in a pair of gate-shaped structures, the communication antennas includes the antennas provided at the entrance, the antennas provided at the exit, and middle communication antennas provided almost half way between the antennas provided at the entrance and the antennas provided at the exit.

8. The wireless tag reader/writer according to claim 6, wherein the weak electric waves are too week to leak outside the gate-shaped structures.

9. The wireless tag reader/writer according to claim 7, wherein the weak electric waves are too week to leak outside the gate-shaped structures.

10. A communication method for use in a wireless tag reader/writer having a plurality of communication antennas arranged in a direction in which wireless tags pass and configured to transmit and receive signals to and from the wireless tags, comprising:
radiating electric waves of a first intensity from the communication antennas which are provided at the entrance or exit of a passage of wireless tags;
radiating electric waves of a second intensity from the communication antennas which are provided at the entrance or exit of a passage of wireless tags, the second intensity being different from the first intensity; and
selecting a wireless tag with which the wireless tag reader/writer is to communicate, in accordance with communication results.

11. A communication method for use in a wireless tag reader/writer having a plurality of communication antennas arranged in a direction in which wireless tags pass and configured to transmit and receive signals to and from the wireless tags, comprising:
radiating electric waves of a first intensity from the communication antennas which are provided at the entrance or exit of a passage of wireless tags;
determining existence of wireless tags;
radiating electric waves of a second intensity from the communication antennas which are provided at the entrance or exit of a passage of wireless tags, the second intensity being lower than the first intensity; and
selecting a wireless tag with which the wireless tag reader/writer is to communicate, in accordance with communication results.
